(19) United States
(12) Patent Application Publication
(10) Pub. No.: US 2016/0316630 A1
(43) Pub. Date: Nov. 3, 2016

(54) Dual Bale Lifting Device

(71) Applicant: Larry Lee, Buckatunna, MS (US)

(72) Inventor: Larry Lee, Buckatunna, MS (US)

(21) Appl. No.: 15/071,358

(22) Filed: Mar. 16, 2016

Related U.S. Application Data
(60) Provisional application No. 62/155,590, filed on May 1, 2015.

(51) Int. Cl. A01D 87/12

(52) U.S. Cl. CPC A01D 87/126; A01D 87/122

(57) ABSTRACT

A dual bale lifting device. The dual bale lifting device includes a frame with a vertical member mounted to one end. The frame is configured to be mounted to a vehicle, such as a tractor. A first spike is rigidly mounted onto one end of the frame and a second spike is mounted onto a slidable element, which is situated within a track of the vertical member. The slidable element is vertically adjustable within the track. A latch is positioned on the vertical member and is configured to lock the slidable element in an upward position. When the latch is released, the slidable element and second spike thereon are lowered under the force of gravity.

### CROSS REFERENCE TO RELATED APPLICATIONS

This application claims the benefit of U.S. Provisional Application No. 62/155,590 filed on May 1, 2015. The above identified patent application is herein incorporated by reference in its entirety to provide continuity of disclosure.

### BACKGROUND OF THE INVENTION

The present invention relates to bale lifting devices. More specifically, the present invention relates to devices configured to pierce and lift a first bale, move to a second location and pierce and lift a second bale, allowing both bales to be moved simultaneously.

Bales are large bundles of compressed material that have been shaped into uniformly sized objects, making them easier to transport and store. Though most bales are made from unused stalks of produce, such as wheat or barley, they can also be made from other material such as plastics. The materials are often compressed using large machines that create and deposit the bales in the middle of a field. In order to ensure maximum storage efficiency, bales are often made to be quite large and heavy, requiring special equipment to move them from the field to a storage location or to be transported onto a vehicle.

Devices have been disclosed in the prior art with various methods of moving bales efficiently. Many of these devices rely on long spikes that are positioned to pierce a single bale, lift it off the ground, and move it to a final destination. Some devices are equipped with multiple spikes to allow more than one bale to be moved simultaneously. A major drawback of this design is that it requires the initial position of the center of the bales to line up with the spacing of the spikes. This is necessary when there are multiple spikes rigidly mounted to a frame at the same height relative to the ground and the height of each spike it not able to be adjusted independently. In this scenario, if an operator attempts to pierce second bale after a first bale is pierces individually, it will have to be dragged on the ground while moving forward to pierce a second bale, causing damage to the first bale. While it is possible to have a device with spikes that can be moved individually, these usually require motorized elements that are expensive to produce and require costly maintenance and upkeep.

### SUMMARY OF THE INVENTION

In view of the foregoing disadvantages inherent in the known types of bale lifting devices now present in the prior art, the present invention provides a bale lifting device wherein the same can be utilized for providing convenience for the user when desiring to move two bales simultaneously by means of a non-motorized mechanical device when the two bales are not initially located in a single area. The present invention comprises a frame with a vertical member mounted to one end. The frame is configured to be mounted to a vehicle, such as a tractor. A first spike is fixed relative to the frame and a second spike is mounted to a slidable element, which is situated within a track of the vertical member. The slidable element is vertically adjustable within the track. A latch is positioned on the vertical member and configured to lock the slidable element in a raised position. When the latch is disengaged, the slidable element and second spike are released.

The slidable element begins in a lowered position with the first spike level with the center of a bale and the second spike situated closer to the ground. A first bale is pierced by the first spike and the entire frame is raised by the vehicle until the second spike is level with the center of a second bale. The second bale is then pierced. The entire frame is lowered causing the second bale to push the second spike and slidable element upward along the track until the latch locks the slidable element into a raised position that maintains the second spike at substantially the same height as the first spike. The frame is once again raised and both bales are able to be transported simultaneously. This is accomplished without motorized elements integral to the bale lifting device.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the dual bale lifting device with the slidable element in a lowered position.

FIG. 2 shows a perspective view of an embodiment of the dual bale lifting device with the slidable element in a raised position.

FIG. 3 shows a rear perspective view of an embodiment of the dual bale lifting device.

FIG. 4 shows perspective views of an embodiment of the latch of the dual blade lifting device.

### DETAILED DESCRIPTION OF THE INVENTION

Reference is made herein to the attached drawings. Like reference numerals are used throughout the drawings to depict like or similar elements of the dual bale lifting device. The figures are intended for representative purposes only and should not be considered to be limiting in any respect.

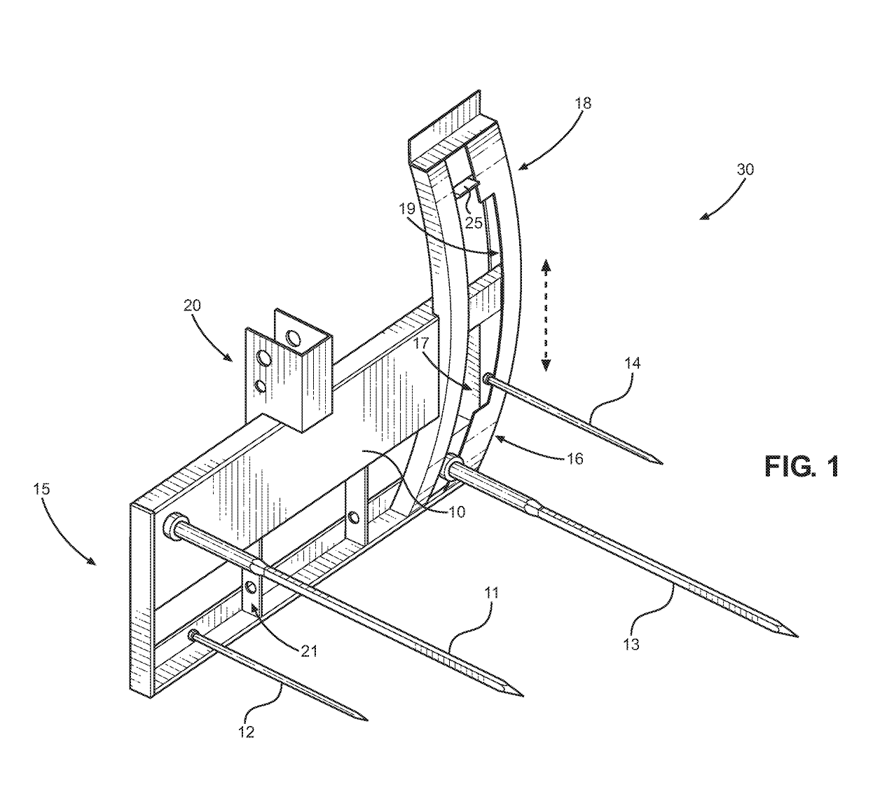

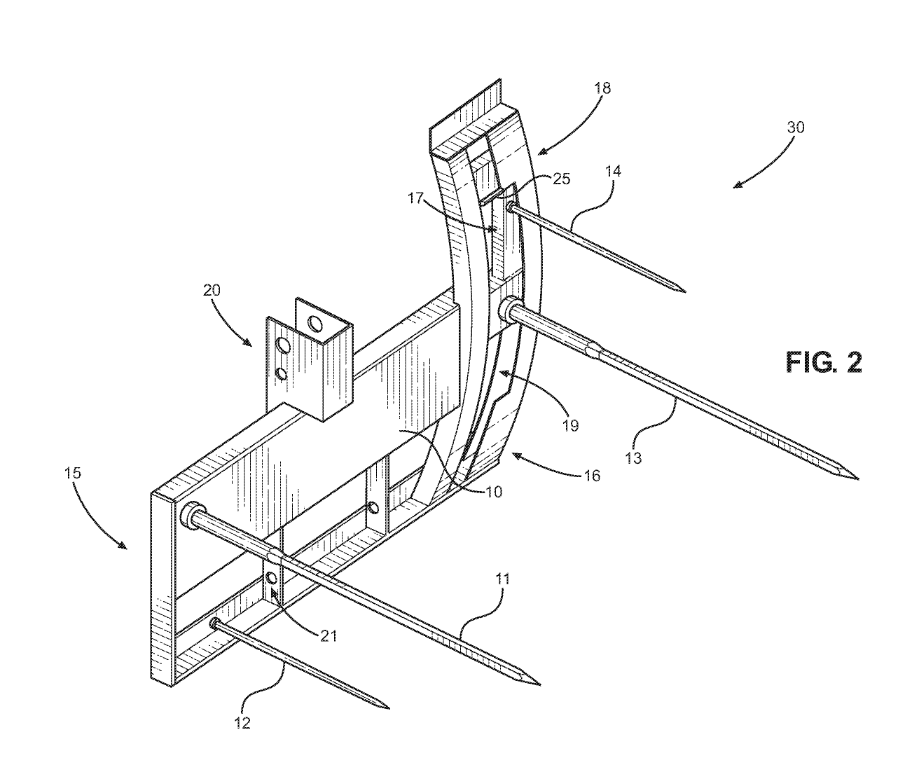

Referring now to FIGS. 1 and 2, there are shown perspective views of an embodiment of the dual bale lifting device. The dual bale lifting device 30 comprises a frame 10 with a vertical member 18. The frame 10 is an elongated structure that is substantially rectangular and positioned in a horizontal orientation wherein the length of the structure is greater than the height. The frame 10 has a first end 15 and a second end 16, the second end 16 having the vertical member 18 with a track 19. A slidable element 17 is movably positioned within the track 19 and adapted to be adjustable between a lowered position and a raised position along the track 19. A first spike 11 is mounted onto the first end 15 of the frame 10, and a second spike 13 is mounted onto the slidable element 17 within the track 19 on the second end 16 of the frame 10. The spikes 11, 13 are substantially elongated rods extending perpendicularly from the frame 10 and are configured to pierce a bale with sufficient depth to allow the pierced bale to be securely moved when a spike 11, 13 is moved.

A latch 25 is disposed on the vertical member 18. The latch 25 is configured to lock the slidable element 17 when the second spike 13 is raised to a height substantially level with the first spike 11, thus preventing the slidable element 17 from moving downwards until the latch 25 is released. The frame 10 is configured to be mounted to a vehicle, such as a tractor. In one embodiment of the invention, the frame 10 additionally comprises mounting brackets 20, 21 that are configured to be directly mounted to a tractor hitch.

In one embodiment of the dual bale lifting device 30 the first spike 11 and the second spike 13 are the only elements that pierce the bale. In another embodiment of the dual bale lifting device 30, there is a first stabilizing pin 12 mounted onto the frame 10 in close proximity to the first spike 11, such that when the first stabilizing pin 12 pierces the center of a bale, the first stabilizing pin 12 also pierces the bale. There is a similarly positioned second stabilizing pin 14 mounted onto the slidable element 17 in close proximity to the second spike 13 and configured to pierce a bale that the second spike 13 has centrally pierced. The stabilizing pins 12, 14 are vertically aligned with the spikes 11, 13 and positioned perpendicular to the frame 10 and are substantially elongated rods that have a shorter length than the spikes 11, 13. The stabilizing pins 12, 14 are configured to pierce a bale with sufficient depth to prevent a bale from rotating around the spikes 11, 13.

In a starting configuration, the slidable element 17 begins in the lowered position. The tractor approaches a first bale, adjusting the frame 10 such that the position of the first spike 11 is level with center of the bale. The frame 10 is moved toward the bale by the tractor, causing the first spike 11 to pierce the first bale. The entire frame 10 is lifted by the tractor to a height such that the second spike 13 is level with the center of a second bale. The tractor is driven forward, allowing the second spike 13 to pierce the second bale. The frame 10 is then lowered to position the first and second bale on the ground. This lowering pushes the second bale and second spike 13 upward, causing the slidable element 17 to move up through the track 19 until the latch 25 engages with the slidable element 17, locking it into a raised position within the track 19. When the frame 10 is subsequently lifted, both spikes 11, 13 and both bales remain level and are lifted simultaneously.

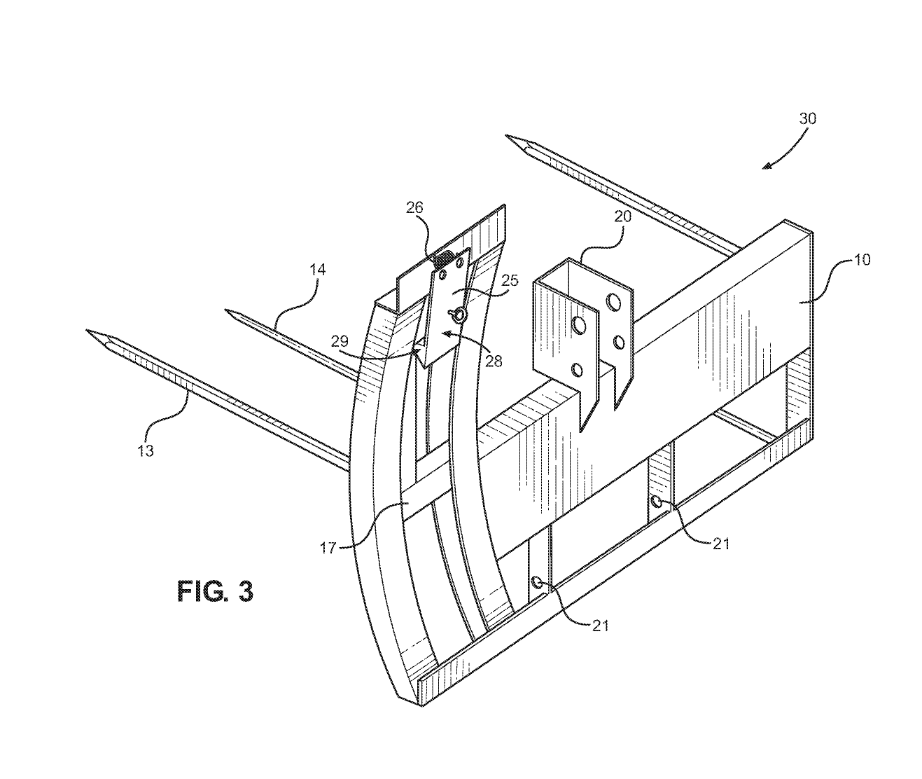

Referring now to FIG. 3, there is shown a rear perspective view of an embodiment of the dual bale lifting device 30. The latch 25 is disposed on the top of the vertical member 18 and configured to lock the slidable element 17 in a raised position. In one embodiment of the invention, the latch 25 has a plate 28 with a shelf 29 positioned substantially perpendicular to the plate 28. The shelf 29 is configured lock the slidable element 17 into place when engaged by the slidable element 17. The latch 25 is configured to have a force applied to it, pushing it toward a locking position. For example, in one embodiment of the invention there is a torsion spring 26 disposed on the vertical member 18 and engaged with the latch 25, wherein the torsion spring 26 is configured to bias the latch 25 toward the slidable element 17.

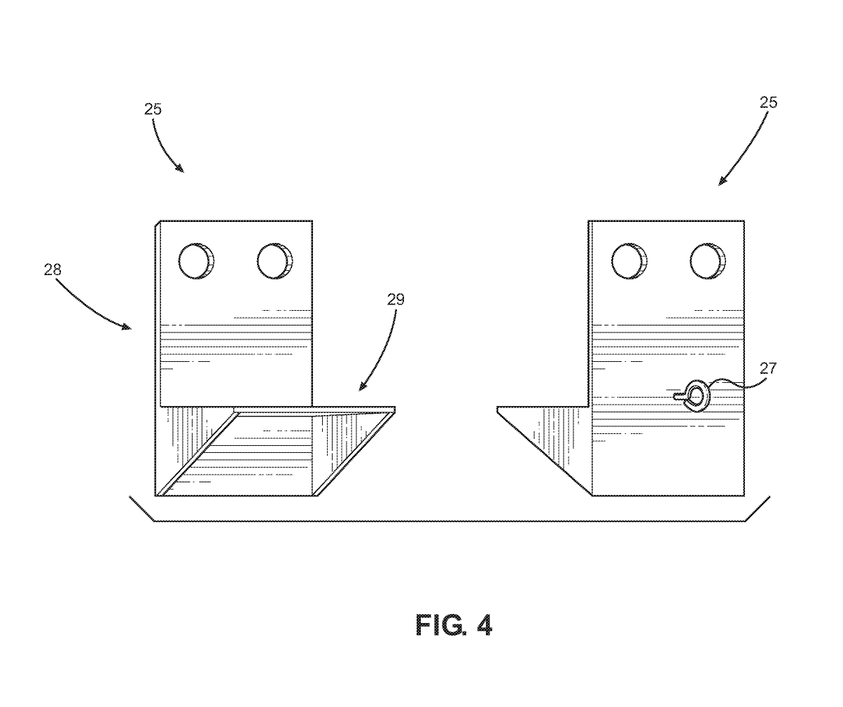

Referring now to FIG. 4, there are shown front and rear perspective views of the latch 25. In one embodiment of the invention, there is an eye screw 27 that is attached to the plate 28 of the latch 25. A rope can be secured to the eye screw 27 on one end, and held by an operator at a second end, allowing the operator to pull the latch 25 away from a locking position, wherein the shelf 29 disengages with the slidable element 17, unlocking and releasing it. In another embodiment of the invention, there is a hook disposed on the plate 28 of the latch 25, wherein a chain can be removably attached to the hook and used to release the latch 25 from a locking position.

The release of the latch 25 permits an operator to deposit a first bale in one location and deposit a second bale in a second location. In order to release two bales, an operator first lowers the frame 10, releases the latch 25, and raises the frame 10. This causes a second bale, with the sliding element 17 and second spike 13, to stay on the ground while the frame 10 and first spike 11 are lifted up. The tractor can then be reversed away from the second bale. Next, the operator transports a first bale to a second location, where the operator lowers the frame 10 once again, placing the first bale on the ground. The tractor can then reverse away a second time, depositing the first bale. Alternatively, if an operator wishes to deposit both bales in the same location, the latch 25 can be left in a locked position and both bales can be placed on the ground simultaneously. When the operator reverses away from the bales, both bales are left in a side by side configuration.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A dual bale lifting device for use with a farming vehicle, comprising:
a frame having a first end and a second end;
a vertical member disposed on the second end of the frame, the vertical member having a track;
a slidable element movably positioned within the track;
a first spike disposed on the first end of the frame, wherein the first spike is configured to secure a bale thereon;
a second spike disposed on the slidable element;
a latch disposed on an upper end of the vertical member and configured to lock the slidable element in a raised position when the slidable element engages with the latch.

2) The dual bale lifting device of claim 1, further comprising:
a first stabilizing pin disposed on the first end of the frame configured to be inserted into a bale secured on the first spike;
a second stabilizing pin disposed on the slidable element configured to be inserted into a bale secured on the second spike.

3) The dual bale lifting device of claim 1, wherein the vertical member is convexly curved relative to the direction of the first spike and the second spike.

4) The dual bale lifting device of claim 1, wherein the frame comprises one or more brackets configured to be secured to a hitch of a tractor.

5) The dual bale lifting device of claim 1, further comprising a torsion spring disposed on the vertical member adjacent to the latch and configured to bias the latch into a locking position.

6) The dual bale lifting device of claim 5, further comprising a hook disposed on the latch and configured to release the latch from a locked position when the hook is drawn away from the vertical member.

7) The dual bale lifting device of claim 1, wherein the latch comprises a plate and a shelf positioned perpendicular thereto.
